(19) United States
(12) Patent Application Publication
(10) Pub. No.: US 2006/0076328 A1
(43) Pub. Date: Apr. 13, 2006

(54) Welding arrangement

(76) Inventors: Kim Peter Hastings, Great Yarmouth, Norfolk (GB); Chris John Cathles, Great Yarmouth (GB)

Correspondence Address: KNOBBE MARTENS OLSON & BEAR LLP, 2040 MAIN STREET, FOURTEENTH FLOOR, IRVINE, CA, 92614, US

(21) Appl. No.: 10/536,367

(22) PCT Filed: Dec. 10, 2003
(86) PCT No.: PCT/GB03/05382

§ 371 Date: May 25, 2005

(30) Foreign Application Priority Data
Dec. 11, 2002 (GB) 0228812.4

(51) Int. Cl. B23K 9/12

(52) U.S. Cl. 219/125.11

(57) ABSTRACT

A welding arrangement (5, 23) for welding pipe sections (6, 7) comprises a power supplying and gas supplying unit (7, 24), a welding unit operatively connected to the power supplying and gas supplying unit and adapted at least in part to displace about the circumference of the pipe (6, 7) during the welding operation, and means whereby the power and gas are transmitted to the welding unit through a transmitting ring (8, 27) sufficient in diameter to extend around the pipe (6, 7) during the welding operation and thereby enabling the power and gas supply unit (7, 24) to remain stationary during the welding operation.

### FIELD OF THE INVENTION

The present invention relates to arrangements employed for welding pipes. More specifically the invention relates to welding arrangements which are incorporated in mobile pipe-laying vehicles or vessels.

### PRIOR ART KNOWN BY THE APPLICANTS

One illustrative prior art arrangement for welding pipes to form an underwater pipeline is presented in patent application PCT/EP99/10504 of SAIPEM S.P.A. This prior art document is primarily concerned with a welding arrangement through which the pipe sections are progressively fed along essentially the vertical axis and which are destined for so-called J-laying to the seabed. The principal arrangement described therein, comprises a rotary platform onto which are located both the power supplying and gas supplying units alongside any user operating the welding guns. This arrangement also comprises a plurality of welding guns which are each associated with a respective sector of the rotary platform and are adapted to run along a guide track around the pipe section. The welding guns are adapted to rotate as the associated platform revolves around a particular pipe section.

### OBJECTIVES OF THE INVENTION

When laying a pipeline at sea or in the ground, it is customary to weld the pipe sections on a pipe-laying vehicle or vessel.

Laying pipelines from a relatively elevated station onto the seabed, will subject these to high levels of force in any combination of tension, compression, bending and twisting and should the quality of the weld not be sufficient, mechanical failure may result. Any such mechanical failure may cause serious delay to the pipe-laying process and may even be hazardous during the pipe-laying process itself or during the pipe-line's later use.

It is therefore an objective of the present invention to provide an arrangement destined to achieving a high standard of weld quality.

Several methods of assessing the quality of the welds have been developed and are currently in use to assist in limiting the occurrence of mechanical failure. One important consideration in designing appropriate welding arrangements is facilitating the ease of access to operators of the joints so that such quality tests can be rapidly carried out.

The present invention will therefore aim to improve the accessibility of the welding arrangement generally, of the joints and more specifically of the welding guns.

In an effort to accelerate the pipe-laying process, arrangements have been devised in which certain welding components are remote controlled and/or displaced automatically. The automation of these systems has added complexity to the systems when compared to conventional manually operated arrangements. Consequently, pipe-laying time has been reduced while in certain arrangements rendering more difficult the accessibility to the welded joints of the pipe.

A further aim of the present invention is therefore to provide an automated arrangement which allows enhanced accessibility to both the joints and welding apparatus and achieves a reduction of pipe-laying time.

An additional objective of the present invention is to improve the manner in which the welding guns are displaced and controlled in order to reduce the welding time required and ameliorate the quality of the weld and rate at which the pipe is laid.

A further objective of the present invention is to render the attachment of the welding guns' assembly to the pipe more versatile and practical to use.

By introducing this present invention, it is expected that other beneficial consequences than those outlined above will follow and which include for example an improvement to the maintenance properties of the welding arrangement and a reduction in pipe-laying costs.

### SUMMARY OF THE INVENTION

In its broadest aspect, the invention presents a welding arrangement for welding pipe sections, the arrangement comprising a power supplying and gas supplying unit, a welding unit operatively connected to the power supplying and the gas supplying unit and adapted at least in part to displace about the circumference of the pipe during the welding operation, and means whereby the power and gas are transmitted to the welding unit through a transmitting ring sufficient in diameter to extend around the pipe during the welding operation and thereby enabling the power and gas supply unit to remain stationery during the welding operation.

This configuration is particularly advantageous because it allows easy access for operators to the weld area should such access be required. The transmitting ring feature is, on its own, particularly advantageous in the context of continuous welding as it allows power and gas to be supplied without requiring the use of extension transmission means. In this context, the distance between the power supplying and gas supplying unit and the transmitting ring and/or the distance between the transmitting ring and the welding unit may be essentially constant. This configuration is also advantageous because it can be employed with a wide variety of pipe sections with deferring diameters and wall thicknesses.

In a subsidiary aspect, the welding unit comprises one or more gun units and one or more feeder units, the or each gun unit being adapted to displace about the circumference of the pipe and utilising for such displacement power means which are separate from the power supplying unit.

In this configuration, access to the weld area and its associated welding gun units is improved as there will be for example no power leads between the power supplying unit and the welding gun units. Providing displacement means which are separate from the power supplying unit will also be particularly beneficial when the welding arrangement is employed in continuous welding.

In a further subsidiary aspect, the welding unit comprises one or more gun units and one or more feeder units, the or each gun unit being adapted to displace about the circumference of the pipe by following a track located in the vicinity of the weld and the or each feeder unit being displaced essentially to follow the displacement of the or each gun unit and being sufficiently spaced from the or each gun unit to allow the operator independent access to the or each gun unit and the or each feeder unit.

This particular arrangement is advantageous because it improves the accessibility both during operation and idle periods. Consequently, any maintenance required or wire spool replacement is also improved.

In a further subsidiary aspect, the welding units are adapted to displace about the circumference of the pipe by following a track which is formed on a band which is sufficiently resilient to stretch to fit around an outer diameter of a pipe.

This configuration particularly improves the rate at which welding units are mounted to the relevant pipe sections and removed thereafter. This feature ameliorates the overall rate at which the pipeline is formed and laid.

In a further subsidiary aspect, the band is sufficiently elastic to tend to resume its original configuration when subsequently removed from the pipe.

This aspect allows the advantageous re-use of the band and is therefore particularly cost effective and simple to use in practice.

In a further subsidiary aspect, the welding unit comprises one or more gun units and one or more feeder units, and wherein the transmitting ring operates about its outer circumference one or more tracks along which the or each feeder unit displaces.

This configuration is particularly advantageous because it is relatively compact. When configured in this manner, the arrangement allows straightforward access to the various sections of the arrangement. When this arrangement is employed in so-called ‘S-Lay’, it is particularly versatile and compact allowing improved accessibility to the operator.

In a further subsidiary aspect, the welding unit incorporates one or more stationary feeders which supply two or more gun units through umbilical means, each gun unit being adapted to displace about a respective part of a circumference of the pipe and each gun unit displacement being powered by its own power supplying unit.

This configuration reduces the number of rotations required by the gun units while achieving improved accessibility.

### BRIEF DESCRIPTION OF THE DRAWINGS

FIG. 1 shows a schematic side elevation of a pipe-laying vessel.

FIG. 2 is a schematic representation of a welding arrangement in a first embodiment of the invention.

FIG. 3 is a schematic representation of a welding arrangement in accordance with a second embodiment of the present invention.

FIG. 4 shows a further schematic presentation of a welding arrangement.

### DETAILED DESCRIPTION OF THE DRAWINGS

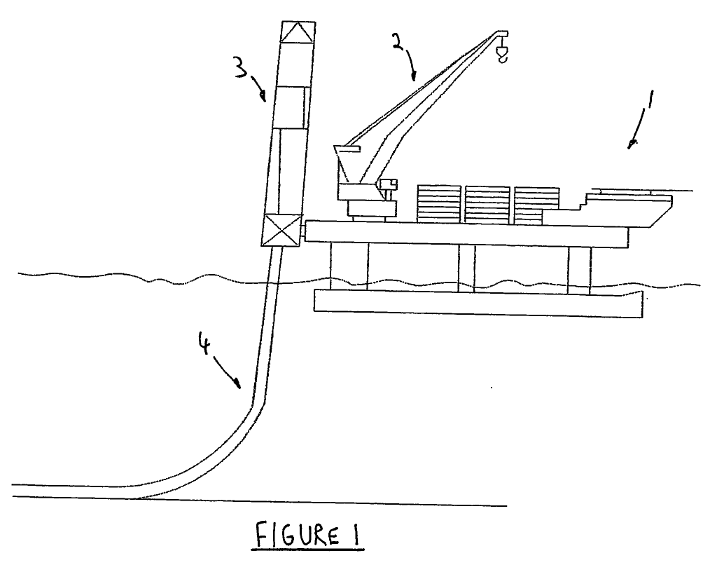

FIG. 1 shows a pipe-laying vessel conducting a so-called ‘J-Lay’ pipeline operation. The vessel 1 comprises a crane 2 susceptible of lifting an appropriate section of pipe and placing it in the vertical plane in a tower 3 constructed on the aft of the pipe-laying vessel. The ‘J-Lay’ pipeline operation follows the steps of adding a section of pipe to the upper end of the tower, lining this section of pipe with a previously loaded section of pipe, welding the sections of pipe, carrying out any appropriate inspection of the joints and then coating at dedicated stations if appropriate and according to specification before lowering the pipe to the seabed. As the pipe is progressively lowered onto the seabed, the pipeline forms a J when viewed in side elevation. Pipe sections may not only be added in single lengths, but double joints or quad joints when for example sections of pipes are welded together and inspected in an on-shore yard prior to being shipped out to the vessel.

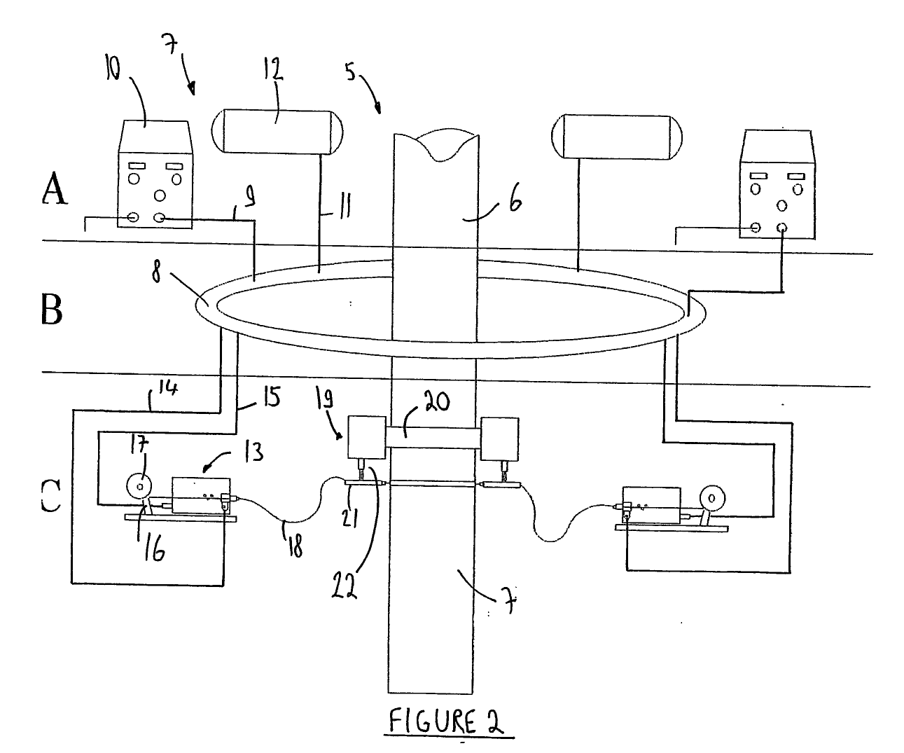

The schematic of FIG. 2 presents a welding arrangement generally referenced at 5. This arrangement is shown operating on the welding of an upper pipe section 6 with a lower pipe section 7. In this embodiment, the pipe is being fed essentially along the vertical axis and would usually be associated with the so-called J-Lay operation described with reference to FIG. 1. Customarily, the pipe sections are clamped or otherwise retained in a tower. For ease of description of this welding arrangement, the welding tower has been purposely omitted in the Figure. The welding arrangement has been split into three sections A, B and C in order to simplify its description.

In section A, the welding arrangement presents the power supplying and the gas supplying unit generally referenced at 7. The invention extends within its scope to any particular type of power supplying and gas supplying unit which will be selected by the person skilled in the art from known alternatives.

Section B of the welding arrangement 5 comprises a transmitting ring 8 which is connected by appropriate connecting means 9 to the power supplying component 10 of the power supplying and gas supplying unit 7. The transmitting ring is also connected by separate connecting means 11 to the gas supplying component 12 of unit 7.

Unit 7 and any other equipment located in section A remains stationary during the welding process.

In section B the transmitting ring 8 transmits separately the power and gas to feeder units such as feeder unit 13 through connecting means 14 and 15.

In section C (although not specifically illustrated) of the welding arrangement 5, means are provided to displace feeder units 13 as appropriate about the circumference of the pipe during the welding operation. Feeder unit 13 may for example be mounted on a rotating platform as the feeder unit 13 is displaced about the circumference of the pipe. Connecting means 14 and 15 will correspondingly displace and engage the transmitting ring 8 at different locations throughout any such displacement.

The specific means for facilitating the transmission of both power and gas at any location will be selected by the person skilled in the art from known alternatives. The transmitting ring 8 may for example incorporate a channel along which the engaging part of connecting means 15 runs during displacement and which is provided with appropriate sealing means to prevent any escape of gas during the displacement of the engaging part of the connecting means 15 relative to a stationary transmitting ring 8. For transmitting power through the transmitting ring 8, a conducting track may be provided throughout the transmitting ring along which an engaging part of connecting means 14 runs when feeder unit 13 is displaced about the circumference of the pipe.

The feeder unit 13 comprises a holder 16 onto which a welding wire spool 17 may be mounted. In the configuration presented in FIG. 2 easy access to spools 17 is facilitated and will allow rapid replacement of wire should any such replacement be required.

The feeder unit 13 supplies gas and welding wire via a flexible umbilical 18 to the welding gun unit 19.

The welding gun unit 19 is adapted to follow a track formed on a band 20 attached to the circumference of the upper pipe section 6. Rendering band 20 resilient may be particularly advantageous in terms of mounting the band on a variety of pipe diameters. The invention also includes in its scope that the bands are rigid and may be attached to any pipe section through conventional clamping mechanisms.

Welding gun unit 19 is powered for its displacement along band 20 by its own power means which are separate from the power supplying unit. The person skilled in the art will envisage appropriate power means for this application such as a conventional battery which would require periodic replacement or recharging and which would be contained within the casing of the welding gun unit.

The present embodiment illustrates each welding gun unit with a single gun. Each welding gun unit may of course incorporate two or more guns each, should the person skilled in the art so choose.

The welding gun unit 19 operates a single gun 21. It is envisaged that means are provided to modify the position of the gun relative to the pipe section. Such systems may include a hydraulic arm 22.

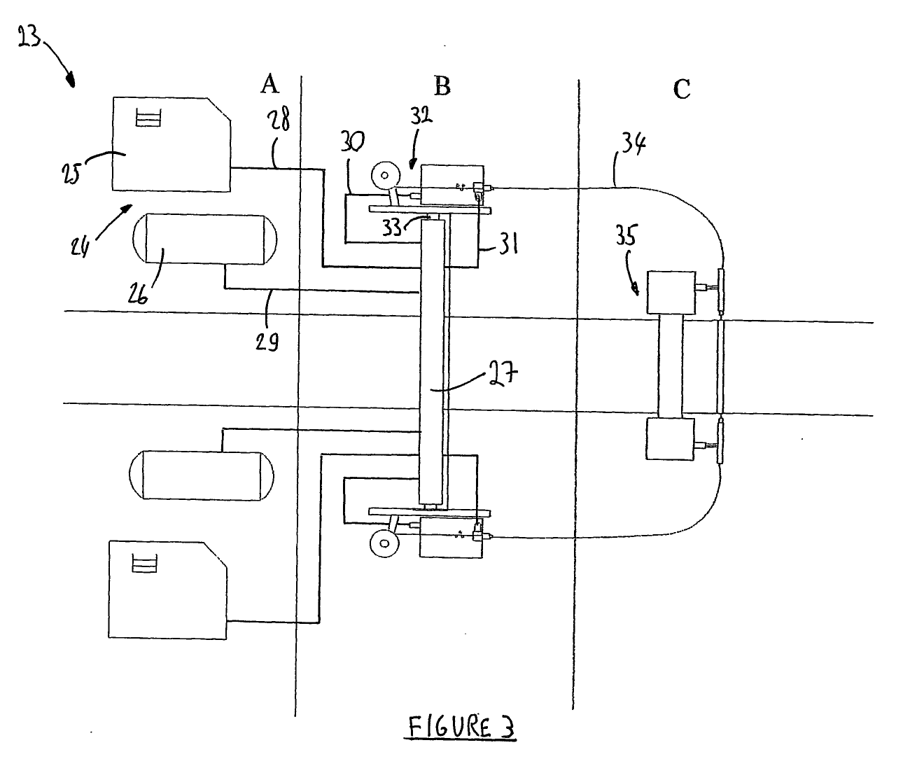

FIG. 3 shows a horizontal welding arrangement 23 which could be used in the context of so-called ‘S-Lay’ operations. In section A there is provided a power supplying and gas supplying unit 24 incorporating a power supplying component 25 and a gas supplying component 26. Unit 24 is stationary during the welding operation. The units and components in section A have therefore essentially the same function as the elements in section A of FIG. 2.

Section B, shows a transmitting ring 27 sufficient in diameter to allow the passage of a variety of pipes. In this embodiment, the transmitting ring 27 is mounted along the vertical axis.

Connecting means 28 and 29 similar to those described with reference to FIG. 2 extend between the power supplying and gas supplying unit 24 and the transmitting ring 27. Transmitting ring 27 engages with the connecting means 30 and 31 which transmit power and gas to the feeder unit 32.

The feeder unit 32 is mounted on a track 33 located about the outer circumference of the transmitting ring. Track 33 represents by its location a protective layer to the outside of the transmitting ring and may be adapted by the person skilled in the art to contribute to the insulation of the transmitting ring 27.

As the feeder unit 32 runs along the track 33, the engaging part of connecting means 28 and 29 remain stationary while the engaging part of connecting means 30 and 31 are displaced.

A connecting means 34 is provided to connect the unit of section B with the welding gun unit 35 of section C. The configuration of welding gun unit 35 may be similar to that of welding gun unit 19 and therefore need not be described in detail in the present context.

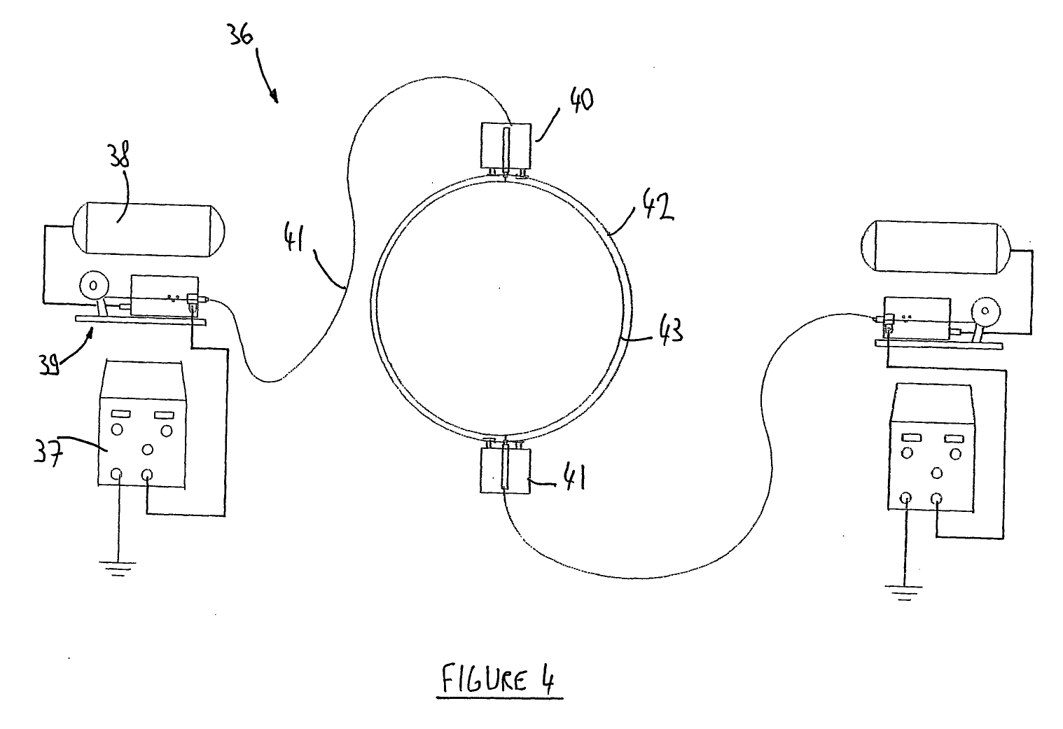

FIG. 4 shows a welding arrangement generally referenced 36 comprising a power supplying component 37 and a gas supplying component 38 operatively connected to a feeder unit 39 linked to a welding gun unit 40 via an umbilical means 41. The arrangement 36 includes a further welding gun unit 41 located opposite unit 40. A band 42 may be mounted on a pipe section 43 similar in configuration to band 20 described with reference to FIG. 2. Each welding gun unit will be adapted to displace along band 42 and cover half the circumference of the pipe section. This configuration allows feeder unit 39 to remain stationary alongside the power supplying and gas supplying unit while the welding gun units 40 and 41 displace. The displacement of these units may be supplied by their own battery means contained within the units and may be automated and remote controlled according to the skilled person's specification.

It is also envisaged to supply to the welding arrangements of the above embodiments, means to assess the position of the welding gun relative to the weld region.

It is also envisaged that means are provided to control the position of the welding gun relative to the weld region as the relative position is assessed. These control means may be remote control means which allow the welder to modify criteria such as amplitude as the welding gun displaces on its tracks. A predetermined limit as to the extent to which a welder may modify criteria is envisaged which would reflect prescribed welding protocols.

1-8. (canceled)

9. A welding arrangement for welding pipe sections, the arrangement comprising:
a power supplying and gas supplying unit;
a welding unit;
means for operatively connecting the welding unit to the power supplying and gas supplying unit;
means for displacing about the circumference of the pipe during the welding operation; and
a transmitting ring for transmitting power and gas from said power supplying and gas supplying unit to said welding unit; the transmitting ring having a diameter which is sufficient to extend around the pipe during the welding operation and thereby enabling the power and gas supply unit to remain stationary during the welding operation.

10. A welding arrangement according to claim 9, wherein the transmitting ring is a stationary transmitting ring.

11. An arrangement according to claim 9, wherein the welding unit comprises at least one gun unit and at least one feeder unit, whereby the gun unit displaces about the circumference of the pipe and utilizes for such displacement power means which are separate from the power supplying unit.

12. An arrangement according to claim 9, wherein the welding unit comprises at least one gun unit and at least one feeder unit, whereby the gun unit displaces about the circumference of the pipe by following a track located in the vicinity of the weld and the feeder unit displaces essentially to follow the displacement of the gun unit and is sufficiently spaced from the gun unit to allow the operator independent access to the gun unit from the feeder unit.

13. An arrangement according to claim 9, further comprising a track formed on a band which is sufficiently resilient to stretch to fit around an outer diameter of a pipe and means for displacing the welding units about the circumference of the pipe by following said track.

14. An arrangement according to claim 13, wherein the band is sufficiently elastic to tend to resume its original configuration when subsequently removed from the pipe.

15. An arrangement according to claim 9, wherein the welding unit comprises at least one gun unit and at least one feeder unit, and wherein the transmitting ring incorporates about its outer circumference at least one track along which the feeder unit displaces.

16. An arrangement according to claim 9, wherein the welding unit incorporates at least one stationary feeder which supplies at least two gun units through umbilical means; means for displacing each gun unit about a respective part of the circumference of the pipe; and a power supplying unit for powering each gun's unit displacement.
